(19) United States
(12) Patent Application Publication
(10) Pub. No.: US 2023/0382688 A1
(43) Pub. Date: Nov. 30, 2023

(54) ELEVATOR INSTALLATION FOR SERVING PUBLIC AND NON-PUBLIC BUILDING ZONES

(71) Applicant: Inventio AG, Hergiswil (CH)

(72) Inventor: Lukas Finschi, Ebikon (CH)

(21) Appl. No.: 18/248,877

(22) PCT Filed: Oct. 5, 2021
(86) PCT No.: PCT/EP2021/077328

§ 371 Date: Apr. 13, 2023

(30) Foreign Application Priority Data
Oct. 21, 2020 (EP) 20203012.8

(51) Int. Cl. B66B 13/14; B66B 1/06; B66B 1/34; B66B 5/00; B66B 3/00

(52) U.S. Cl. CPC B66B 13/146; B66B 1/06; B66B 1/3407; B66B 5/0012; B66B 3/002; B66B 1/3461; B66B 2201/30

(57) ABSTRACT

An elevator installation has an elevator car that is moved in an elevator shaft between floors of a building under control of an elevator controller. The car has a first car door on a first car wall and a second car door on a second car wall. A first group of shaft doors is arranged in public zones of the building and a second group of shaft doors is arranged in non-public zones of the building. The elevator controller has a first operating mode in which the public zones are served; accordingly, only the first car door and the shaft doors for the public zones are actuated. In a second operating mode, the non-public zones are served, and accordingly only the second car door and the shaft doors for the non-public zones are activated.

### FIELD

The technology described herein relates in general to an elevator system in a building. Exemplary embodiments of the technology relate in particular to an elevator installation with an access control function and a method for operating such an elevator installation.

### BACKGROUND

Access to a building or access to access-restricted zones within the building can be controlled in various ways. For example, an access control system can unlock a physical barrier (e.g., door, barrier or locks) and release it for a user if the user has a valid credential, depending on the technology used in the access control system, for example, a key, an access code (PIN, optical code (barcode, QR code, color code). It is known from EP 2 588 399 B1 that an access control function can also be performed in conjunction with an elevator installation.

Although the above-mentioned approaches control access to a building or to its access-restricted zones, there may be a requirement for an additional control functionality in a building without thereby providing complex changes to the building or its infrastructure. There is therefore a need for a technology that fully or at least partially meets these requirements.

### SUMMARY

One aspect of the technology described here relates to an elevator installation which has an elevator controller, at least one elevator car and a number of shaft doors. The elevator car can be moved between floors of a building in an elevator shaft by the elevator controller and has two car doors, a first car door on a first car wall and a second car door on a second car wall. The shaft doors separate the elevator shaft from the floors, wherein a first group of shaft doors are arranged in public zones of the building and a second group of shaft doors are arranged in non-public zones of the building. The elevator controller has a first operating mode and a second operating mode. In the first operating mode, the elevator controller is configured to move the elevator car between the floors and to serve the public zones. On a floor to be served, the elevator controller controls an opening of the car door, which, on the floor to be served, causes an opening of the shaft door arranged in the public zone there. In the second operating mode, the elevator controller is configured to move the elevator car between the floors in order to serve the non-public zones. On a floor to be served, the elevator controller controls an opening of the car door, which, on the floor to be served, causes an opening of the shaft door arranged in the non-public zone there.

Another aspect of the technology described here relates to a method for operating an elevator installation. In this case, the elevator installation is configured as described in the preceding paragraph. The method comprises operating the elevator controller according to a first operating mode or a second operating mode. In the first operating mode, the elevator car is moved between the floors in a controlled manner by the elevator controller in order to serve the public zones, wherein on a floor to be served the elevator controller controls an opening of the car door which, on the floor to be served, causes an opening of the shaft door arranged in the public zone there. In the second operating mode, the elevator car is moved between the floors in a controlled manner by the elevator controller in order to serve the non-public zones, wherein the elevator controller on a floor to be served controls an opening of the car door which, on the floor to be served, causes an opening of the shaft door arranged in the non-public zone there.

The technology described here makes it possible to equip an elevator installation with an access control function that is an alternative to the prior art. The elevator controller has a first operating mode and a second operating mode and can switch between these two operating modes. In the first operating mode, the elevator controller moves the elevator car only from and to floors with public zones, and in the second operating mode the elevator controller moves the elevator car only from and to floors with non-public zones. In this way, a floor can be defined in the building which serves as an access control floor; for example, a reception area of a company or a hotel reception can be located there. A passenger who, for example, enters the building via a public zone of the building and inputs an elevator call there, can initially only be transported by the elevator installation into another public building zone, in particular on the access control floor. After being detected in the reception area or reception, they can enter the non-public zone on the access control floor in order to be conveyed from there to a desired utilization floor in the building.

The technology described here also makes it possible for the access control floor to be served in the aforementioned manner without an additional shuttle elevator being required which only serves floors with public zones. Specifically, the two operating modes make it possible for the same elevator (and thus, for example, also the same elevator shaft) to be used not only for trips between floors with public zones but also for trips between floors with non-public zones. Since no shuttle elevator is required, less space is required for the elevator installation in the building. The building can then be planned and constructed, for example, with a smaller footprint, or the space no longer needed will be available for a different use. The smaller space requirement of the elevator installation allows, for example, architects to have more freedom in the planning and design of buildings.

In one exemplary embodiment, the access control function is supported by the fact that a switch between the two operating modes is possible only when a status signal generated by a monitoring device indicates that no passenger is present in the elevator car. In other words, in one exemplary embodiment, before a change of operating mode a check can be made whether the elevator car is empty. In one exemplary embodiment, the monitoring device is arranged in the elevator car.

In one exemplary embodiment, an information unit is arranged in the elevator car, which is communicatively connected to the elevator controller. Controlled by the elevator controller, the information unit generates a notification, in particular an audiovisual notification, which prompts the passenger to leave the elevator car, for example when the elevator car has arrived at the destination floor and the elevator controller has to change the operating mode.

In one exemplary embodiment, the information unit generates a notification informing the passenger that only floors with public zones, in particular the access control floor, will be served. Such a notification is made, for example, when the passenger enters the elevator car from a public zone. The notification can also inform or request the passenger to go to the reception.

In addition or as an alternative to the notification of the passenger in the elevator car, in one exemplary embodiment, notification of the passenger can already take place in the public zone on a floor. Due to the aforementioned possibilities for notifying the passenger, the passenger is assisted in using the elevator installation and in orienting themselves in the building.

The technology described here is not restricted to an elevator installation with a single elevator. It can also be used in conjunction with an elevator group or several elevator groups. In one exemplary embodiment, the elevator installation comprises a group of elevators, wherein one elevator in this elevator group comprises the at least one elevator car and the other elevators in the group each have an elevator car with a first and a second car door. In this exemplary embodiment, each elevator car thus has a car door on two of the car walls. In one exemplary embodiment, the elevators of the elevator group in the building are arranged next to one another in a row.

In one exemplary embodiment, not all elevator cars of an elevator group are equipped with such two car doors. The technology described herein enables design freedom in this regard, thereby making cost savings possible without restricting the access control function provided by the technology.

In an elevator group, the arrangement of the elevators is not limited to the aforementioned arrangement in a row. In one exemplary embodiment, an elevator sub-group has elevators which each have an elevator car with a single car door. In the remaining part (one or more elevators) of the elevator group each elevator car has two car doors. The elevators of the elevator group are arranged in the building such that on the access control floor the second car door of the at least one elevator car and the single car doors of the elevator sub-group open onto the first non-public zone. The non-public zone is thus located in the space between the elevator sub-group and the remaining part of the elevator group.

### DESCRIPTION OF THE DRAWINGS

Various aspects of the improved technology are described in greater detail below with reference to exemplary embodiments in conjunction with the drawings. In the figures, identical elements have identical reference signs. In the figures:

FIG. 1 is a schematic representation of an exemplary situation in a building with multiple floors and of an exemplary elevator installation;

FIG. 2 is a side view of a schematically illustrated building with an exemplary elevator installation with four elevators;

FIG. 3 is a plan view of the elevator installation according to FIG. 2 on a level of an access control floor;

FIG. 4 is a plan view of the elevator installation according to a further exemplary embodiment on a level of the access control floor;

FIG. 5 is an exemplary representation of a first exemplary embodiment of a method for operating the elevator installation;

FIG. 6 is an exemplary representation of a second exemplary embodiment of a method for operating the elevator installation; and

FIG. 7 is an exemplary representation of a third exemplary embodiment of a method for operating the elevator installation.

### DETAILED DESCRIPTION

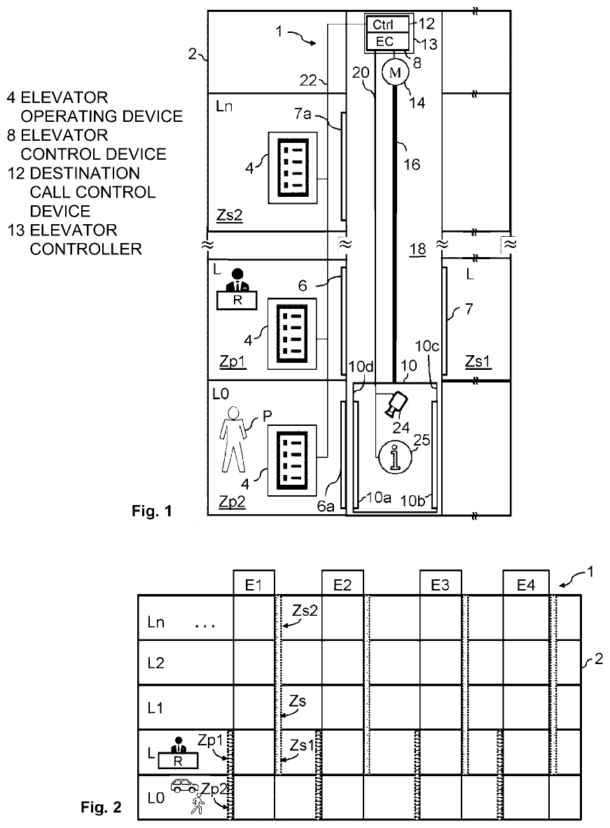

FIG. 1 is a schematic representation of an exemplary situation in a building 2 that has multiple floors L0, L, Ln that are served by an elevator installation 1. According to one exemplary embodiment of the technology described here, building-internal access control is carried out on floor L; in the following, floor L is also referred to as access control floor L. In the situation shown in FIG. 1 the building 2 has at least one floor L0 below the access control floor L and several floors Ln above the access control floor L. Persons can enter the building 2 on, for example, floor L0 in order to use one or more of the floors Ln for a specific purpose. Floor L0 is also referred to below as access floor L0, and a floor Ln is also referred to as a utilization floor Ln. The person skilled in the art will recognize that the designations “access control floor”, “access floor” and “utilization floor” are by way of example and have been chosen here for better differentiation of the floors L0, L, Ln. The person skilled in the art will also recognize that the arrangement and/or organization of the floors L0, L, Ln is tailored to the building 2 and correspondingly can be configured differently than appears in FIG. 1.

For the purposes of illustration, of the elevator installation 1 FIG. 1 shows only an elevator controller 13, a drive machine 14, a suspension means 16 (e.g., steel cables or flat belts), and an elevator car 10 (hereinafter also referred to as car 10), which is suspended on the suspension means 16 and is movable in a shaft 18 under the control of the elevator controller 13, and a number of elevator operating devices 4. A person skilled in the art will recognize that the elevator system 1 can also comprise multiple cars 10 in one or more shafts 18 that are controlled by a group controller. Instead of a traction elevator (shown in FIG. 1), the elevator system 1 can also have one or more hydraulic elevators.

The elevator car 10 shown in FIG. 1 has a first car door 10a on a first car wall 10d and a second car door 10b on a second car wall 10c. In the exemplary embodiment shown, a monitoring device 24 and an information device 25, which are communicatively connected to the elevator controller 13, are arranged in the car 10. The monitoring device 24 is configured to generate a status signal which indicates whether a passenger P is present in the elevator car 10. The monitoring device 24 can comprise, for example, a video camera with an associated image processing device; the presence of a passenger P can thus be detected. The person skilled in the art will recognize that the elevator installation 1 can also be used for transporting an autonomously movable object (robot) or another object; the term “passenger” therefore also includes such objects.

FIG. 1 also shows a number of shaft doors 6, 6a, 7, 7a which separate the elevator shaft 18 from the floors L0, L, Ln. In one exemplary embodiment, a shaft door 6, 6a, 7, 7a is opened and closed by being coupled to one of the car doors 10a, 10b when the elevator car 10 is located on floor L0, L, Ln and can thereby be moved by the car door 10a, 10b. In the exemplary embodiment in FIG. 1, on the access control floor L a first shaft door 6 is arranged in a first public zone Zp1 of the building 2 and a second shaft door 7 is arranged in a first non-public zone Zs1 of the building 2. On the access floor L0 a third shaft door 6a is arranged in a second public zone Zp2 of the building. On the utilization floor Ln a fourth shaft door 7a is arranged in a second non-public zone Zs2. The person skilled in the art will recognize that further public and non-public zones Zp, Zs can be provided in the building.

A communication network 22 connects the elevator operating devices 4 to the elevator controller 13 and thus makes communication possible between the elevator controller 13 and the elevator operating devices 4. For this communication, the elevator operating devices 4 and the elevator controller 13 may be directly or indirectly connected to the communication network 22. The communication network 22 can comprise a communication bus system, individual data lines, or a combination thereof. Depending on the implementation of the communication network 22, individual addresses and/or identifiers may be allocated to the elevator controller 13 and each elevator operating device 4, such that, for example, the elevator controller 13 can send a message to a desired elevator operating device 4 in a targeted manner. Communication can take place in accordance with a protocol for wired communication, for example the Ethernet protocol. In one embodiment, the elevator operating devices 4 are supplied with electrical energy via the communication network 22 (PoE). If the elevator operating device 4 is arranged in the car 10, the communication line 20 is used in one exemplary embodiment for communication and for supplying energy to the elevator operating device 4.

In the situation shown in FIG. 1 and according to an exemplary embodiment of the elevator installation 1 and its mode of operation a control functionality is provided in the building 2 using the elevator installation 1. Summarized briefly and by way of example, two operating modes are provided in the elevator installation 1 according to the technology described here. In a first operating mode, the elevator controller 13 moves the elevator car 10 between the floors L, L0 and serves the public zones Zp1, Zp2. On one of the floors L, L0 to be served, the elevator controller 13 controls an opening of the car door 10a, which, on the floor L, L0 to be served, causes an opening of the shaft door 6, 6a arranged in the public zone Zp1, Zp2 there. In a second operating mode, the elevator controller 13 moves the elevator car 10 between the floors L, Ln and serves the non-public zones Zs1, Zs2. In this case, the elevator controller 13 controls an opening of the car door 10b on one of the floors L, Ln to be served, which on the floor L, Ln to be served causes an opening of the shaft door 7, 7a arranged in the non-public zone Zs1, Zs2 there. As stated elsewhere in this description, the operating mode is changed only when the elevator car 10 is empty.

If, according to one exemplary embodiment, a passenger P wishes to move from the public zone Zp2 on the access floor L0 by taking an elevator to the utilization floor Ln and into the non-public zone Zs2 there, the elevator car 10 will first transport them to the access control floor L. The elevator installation 1 is for this purpose in the first operating mode and the elevator car 10 will move only from and to floors L0, L with public zones Zp1, Zp2. When the passenger P leaves the car 10 on the access control floor L and enters the public zone Zp1, the passenger P can be detected there (e.g., seen, recognized, greeted and/or registered). In this exemplary embodiment, the elevator car is then empty and a change from the first operating mode into the second operating mode can take place. In the second operating mode, the elevator car 10 is moved only from and to floors L, Ln with non-public zones Zs1, Zs2. If, on the access control floor L, the passenger P in this exemplary embodiment then enters from the public zone Zp1, they can enter the car 10 from there in order to be transported to the desired utilization floor Ln.

The access control floor L can comprise, for example, a reception area of a company or a hotel reception, while the company's rooms or the hotel rooms are located on the at least one utilization floor Ln. In the company or the hotel, it can be stipulated that every passenger P must pass by the reception area or reception desk, irrespective of whether they are known/registered or unknown or are in the building 2 regularly or for the first time, in order to be registered by the personnel there. The reception area or the reception desk, or their staff, on the access control floor L thus contribute to implementing an access control function in the building 2.

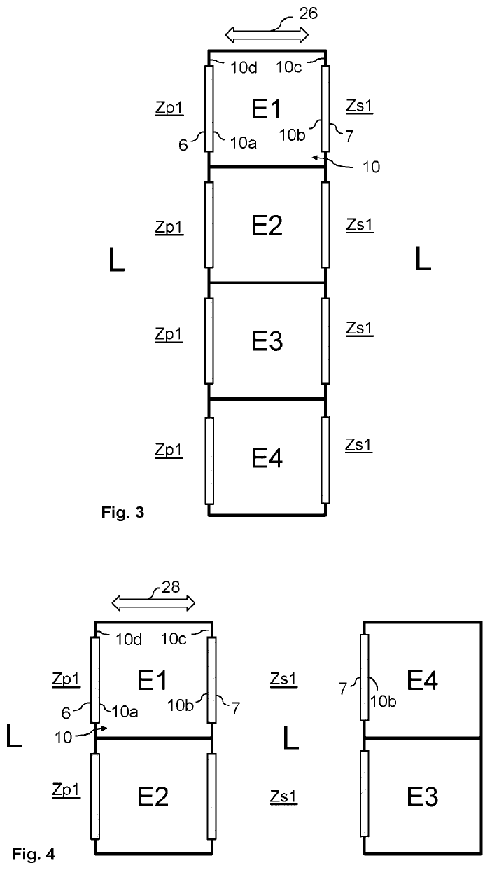

The elevator installation 1 can be configured depending on the type and size of the building 2 and its transportation requirements. Various embodiments of the elevator installation 1 are shown in FIG. 2, FIG. 3 and FIG. 4. FIG. 2 shows a side view of a schematically illustrated building 2 with an exemplary elevator installation 1 with a group of four elevators E1, E2, E3, E4, each of which has an elevator car 10 with two car doors 10b. In the exemplary embodiment shown, the elevators E1-E4 serve the floors L0, L, L1, L2, Ln. On the access control floor L, it is indicated for each elevator E1-E4 that access is there possible from and to the public zone Zp1 and from and to the non-public zone Zs1. On the access floor L0, it is indicated for each elevator E1-E4 that access there is possible from and to the public zone Zp2. On the utilization floors L1-Ln access is only possible from and to the non-public zone Zs, Zs2.

In another exemplary embodiment, not all elevators E1-E4 of the group have two car doors 10a, 10b. For example, the elevators E1 and E2 can each have two car doors 10a, 10b, while the elevators E3 and E4 each have only one car door 10a, 10b. In this case, elevators E3 and E4 only serve the floors L, L1, L2, Ln, while the elevators E1 and E2, as in the preceding exemplary embodiment, serve all the floors L0, L, L1, L2, Ln. The person skilled in the art will recognize that generally not all elevators E1-E4 in the group need to have two car doors each. In FIG. 2, in this exemplary embodiment, on the access floor L0 the hatched areas for the public zones can be omitted in the case of the elevators E3 and E4.

FIG. 3 shows a plan view of the elevator installation 1 according to FIG. 2 on a level of the access control floor L. The elevator installation 1 comprises the group of elevators E1-E4. The elevator E1 comprises the at least one elevator car 10 (FIG. 1), the other elevators E2-E4 in the group, each having an elevator car 10 with a first and a second car door 10a, 10b. In this plan view, the elevators E1-E4 are arranged next to one another (essentially in a row next to each other). From the point of view of a passenger P, the elevators E1-E4 are likewise arranged next to each other in a row. On the access control floor L, the car door 10a is coupled to the floor door 6 (corresponding to the public zone Zp1), and the car door 10b is coupled to the floor door 7 (corresponding to the non-public zone Zs1). An arrow 26 indicates possible directions of movement on the access control floor L. Depending on the operating mode, passengers P can leave the elevators E1-E4 in the direction of the public zone Zp1 or of the non-public zone Zs1 or enter them from there.

FIG. 4 shows a plan view of the elevator installation 1 according to a further exemplary embodiment on a level of the access control floor L. The elevator installation 1 comprises the group of elevators E1-E4. The elevator E1 comprises the at least one elevator car 10 (FIG. 1). An elevator sub-group comprises the elevators E3-E4 of the group, each of which has an elevator car 10 with a single car door 10b. The elevators E1-E4 are arranged in the building 2 such that, on the access control floor L, the second car door 10b of the at least one elevator car 10 and the single car doors 10b of the elevator sub-group open onto the first non-public zone Zs1.

In the exemplary embodiment shown, the elevators E1 and E2 are arranged next to one another and each have an elevator car 10 and the car doors 10a, 10b. On the access control floor L, for each elevator E1, E2, the car door 10a can be coupled to the floor door 6 (corresponding to the public zone Zp1), and the car door 10b can be coupled to the floor door 7 (corresponding to the non-public zone Zs1). The elevators E3 and E4 are also arranged next to one another in this plan view and each have an elevator car 10; each of these elevator cars 10, on the other hand, has only one car door 10b, which on the access control floor L can be coupled to the floor door 7 (corresponding to the non-public zone Zs1). In FIG. 4 it can be seen that the elevators E1 and E2 are arranged opposite the elevators E3 and E4, the non-public zone Zs1 being located between the elevators E1, E2 and the elevators E3, E4.

In the exemplary embodiment in FIG. 4 only the elevators E1, E2 are perceptible from the perspective of a passenger P in the public zone Zp1. An arrow 28 indicates possible directions of movement on the access control floor L. Depending on the operating mode, passengers P can leave the elevators E1 and E2 in the direction of the public zone Zp1 or of the non-public zone Zs1 or enter therefrom; on the other hand, the elevators E3 and E4 can only be left or entered only in the direction of the non-public zone Zs1.

The elevator installation 1 can be equipped with an up/down controller or a destination call controller, for example. The person skilled in the art will recognize that other elevator controllers, e.g., controllers with mobile devices or mixed forms of the aforementioned controllers, are also possible. If the elevator installation 1 is equipped with an up/down controller, elevator operating devices 4 will be arranged on the floors L, L0, Ln, at which elevator operating devices a passenger P can input the desired direction of travel. The entry floor is determined from the location of the elevator operating device 4 at which the direction of travel (i.e., an elevator call) is input. The desired destination floor is then input in the car 10 at the elevator operating device disposed there (not shown in FIG. 1). A communication line 20 connects the (car-side) elevator operating device to the elevator controller 13. If the elevator installation 1 is equipped with a destination call controller, the elevator operating devices 4 will be arranged on the floors L, L0, Ln, on which a passenger P can input a desired destination floor; after the destination floor has been input by the passenger P (i.e., the input of a destination call) information about the entry floor and the destination floor will be available. The entry floor is defined by the location of the elevator operating device 4 at which the destination floor is input. The destination call control device 12 assigns an elevator car 10 to the input destination call, and an elevator control device 8 controls the movement of the assigned elevator car 10 according to the destination call.

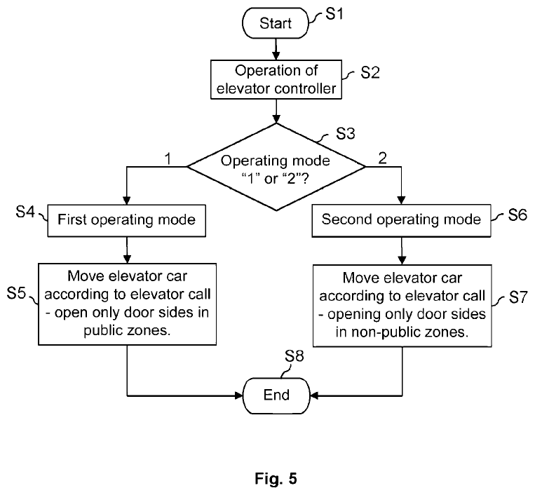

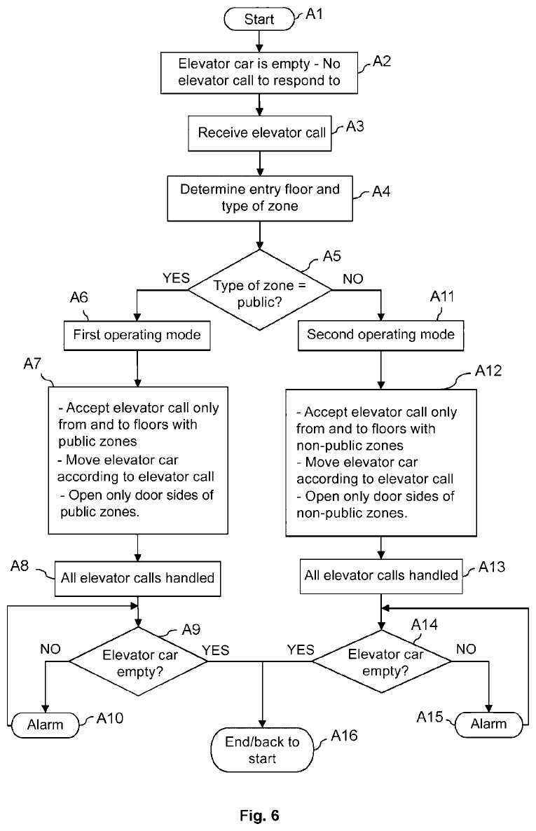

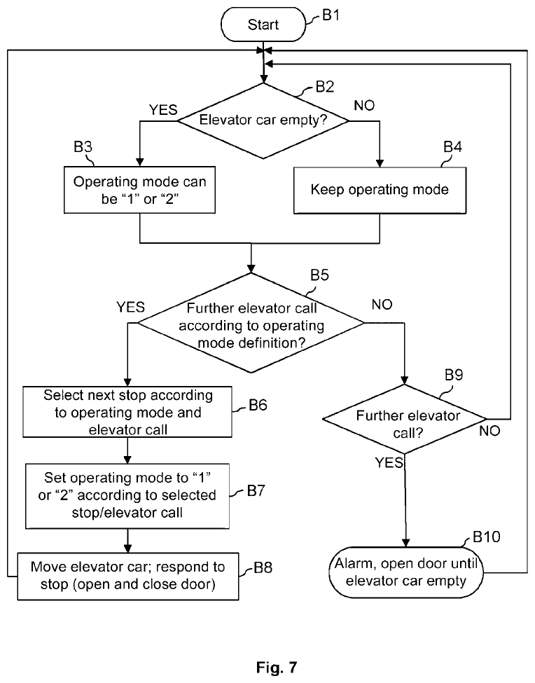

With the understanding of the basic system components of the elevator installation 1 described above and their functionalities, there follow below descriptions of exemplary methods of operating the elevator installation 1 with reference to FIG. 5, FIG. 6 and FIG. 7. The elevator installation 1 can be configured as shown in FIG. 1; multiple elevators E1-E4 can be arranged as shown in FIG. 2 or FIG. 3. The methods are illustrated by means of exemplary flowcharts and steps carried out thereby. A person skilled in the art will recognize that the division into these steps is by way of example, and that one or more of these steps may be divided into one or more sub-steps, or that several of the steps may be combined into one step.

FIG. 5 shows an exemplary representation of a flowchart of a first exemplary embodiment of a method for operating the elevator installation 1. The method begins with a step S1 and ends with a step S8. In a step S2, the elevator controller 13 of the elevator installation 1 is operated according to a first operating mode or a second operating mode. The operation can take place according to one of the two operating modes, which is shown by a decision in a step S3. If operation is to take place according to the first operating mode, the method proceeds along the “1” branch to a step S4 in which the first operating mode is specified as the operating mode. If the operation is to take place according to the second operating mode, the method proceeds along the “2” branch to a step S6 in which the second operating mode is specified as the operating mode.

If the first operating mode has been specified in step S4, the elevator controller 13 controls the elevator car 10 in a step S5 such that it is moved between the floors L, L0 and the public zones Zp1, Zp2 are served. This also means that the elevator controller 13 accepts for operation or execution only elevator calls from and to floors L, L0 with public zones Zp1, Zp2. On a floor L, L0 to be served, the elevator controller 13 controls an opening of the car door 10a, the car door, on the floor L, L0 to be served, initiating an opening of the shaft door 6, 6a arranged in the public zone Zp1, Zp2 there. As stated elsewhere in this description, the car door 10a takes with it the corresponding shaft door 6, 6a on the floor L, L0 to be served.

If the second operating mode has been specified in step S6, in a step S7 the elevator controller 13 controls the elevator car 10 such that it is moved between the floors L, Ln and the non-public zones Zs1, Zs2 are served. This also means that the elevator controller 13 accepts for operation or execution only elevator calls from and to floors L, Ln with non-public zones Zs1, Zs2. On a floor L, Ln to be served, the elevator controller 13 controls an opening of the car door 10b, the car door, on the floor L, Ln to be served, initiating an opening of the shaft door 7, 7a arranged in the non-public zone Zs1, Zs2 there. The car door 10b on the floor L, L0 to be served also takes with it the corresponding shaft door 7, 7a.

In the exemplary embodiment in FIG. 5 the method ends in step S8 after step S5 or step S7.

FIG. 6 shows an exemplary representation of a flowchart of a second exemplary embodiment of a method for operating the elevator installation 1. The method begins with a step A1 and ends with a step A16. The description of this exemplary embodiment is based on a situation in which the elevator car 10 shown in FIG. 1 is empty, which is detected by the monitoring device 24, and in which no elevator call is to be served; step A2 represents this situation.

In a step A3, an elevator call of a passenger P is received. The elevator call can be a destination call or indicate the direction of travel.

In a step A4, the entry floor is determined. The entry floor derives from the floor L, L0, Ln, on which is arranged the elevator operating device 4 where the passenger P inputs the elevator call. The passenger P can be in a public zone Zp or a non-public zone Zs. In step A4, the type of zone (Zp, Zs) where the passenger P is located is also determined and from which the passenger P has to enter the elevator car 10. The determination of the zone type therefore also comprises which of the elevator doors 10a, 10b is to be opened on the entry floor. The elevator operating device 4 used by the passenger P can likewise be arranged in either of the two zones Zp, Zs. In one exemplary embodiment, the type of zone can thus be determined for this elevator call.

In a step A5, it is checked whether the zone is a public zone Zp1, Zp2. If this is the case, the method proceeds along the YES branch to a step A6. If, on the other hand, the zone is a non-public zone Zs1, Zs2, the method proceeds along the NO branch to a step A11.

In step A6, the first operating mode is specified for the elevator controller 13. Since the elevator car 10 is empty (step A2), according to the technology described here, it will be possible to switch from one operating mode to the other operating mode.

In a step A7 following step A6, the elevator call is handled according to the first operating mode. In the first operating mode, the elevator controller 13 only accepts elevator calls from and to floors L, L0 with public zones Zp1, Zp2, and only the doors to the public zones Zp1, Zp2 will be opened (see also step S5 in FIG. 5).

In a step A8 the elevator call of the passenger P and all possible elevator calls present from other passengers (which can be handled in the first operating mode) are handled. The elevator car 10 should therefore be empty.

In a step A9, it is checked whether the elevator car 10 is empty. For this purpose, the signal of the monitoring device 24 is evaluated. If the elevator car 10 is empty, the method proceeds along the YES branch to step A16 where the method ends or returns to the start in step A1.

If the elevator car 10 is not empty, the method proceeds along the NO branch to a step A10. In step A10, an alarm is generated which, for example, notifies building personnel that, inter alia, there is an unauthorized use of the elevator and/or which activates the information unit 25 in the elevator car 10 to generate an audiovisual notification which requests a passenger to leave the elevator car 10.

After the alarm has been generated in step A10, the method can wait for a prespecified period of time in order to check again in step A9 whether the elevator car 10 is empty. This query can be maintained until the elevator car 10 is empty.

In the above-mentioned step A5, the method proceeds along the NO branch to a step A11 if a non-public zone Zs1, Zs2 is concerned. In step A11, the second operating mode is specified for the elevator controller 13. Since the elevator car 10 is empty (step A2), according to the technology described here, it will be possible to switch from one operating mode to the other operating mode.

In a step A12, the elevator call is handled according to the second operating mode. In this operating mode, the elevator controller 13 only accepts elevator calls from and to floors L, Ln with non-public zones Zs1, Zs2, and only the doors to the non-public zones Zs1, Zs2 will be opened (see also step S7 in FIG. 5).

The rest of the steps in this branch A13-A15 are carried out as described in connection with steps A8-A10. In particular, these steps A8-A10 and A13-A15 ensure that the elevator car 10 is empty before an operating mode is switched to the other operating mode (cf. steps A2, A6 and A11).

FIG. 7 is an exemplary representation of a third exemplary embodiment of a method for operating the elevator installation 1. The method begins with a step B1 and runs through loops, which lead back to a step B2 in this exemplary embodiment.

In step B2, it is checked whether the elevator car 10 is empty. For this purpose, the signal of the monitoring device 24 is evaluated. If the elevator car 10 is empty, the method proceeds along the YES branch to a step B3 in which it is determined that the operating mode can be the first operating mode or the second operating mode. If, on the other hand, the elevator car 10 is not empty, the method proceeds along the NO branch to a step B4 in which the current operating mode of the elevator controller 13 is retained. Since the elevator car 10 is not empty, according to the technology described here the operating mode (at the time of execution of step B2) cannot be changed.

Steps B3 and B4 are followed by a step B5. In step B5, it is checked whether at least one elevator call is present according to the operating mode specified in step B3 in which both modes of operation are possible (either the first or the second operating mode) or in step B4 (current operating mode is retained). If such an elevator call is present, the method proceeds along the YES branch to a step B6, otherwise along the NO branch to a step B9.

In step B6, the elevator call present is analyzed in order for the elevator controller 13 to plan a required next stop of the elevator car 10. Here, the floor to be served and the car door 10a, 10b, which must be opened at a stop on the floor to be served according to the elevator call and the operating mode, are selected.

In a step B7, the operating mode is set according to the stop selected in step B6 for the elevator call. The operating mode can be set to the first operating mode or to the second operating mode. There are two cases here: If the operating mode has already been set (i.e., to the first or second operating mode), then the elevator call will assuredly match the operating mode, and the operating mode is maintained. On the other hand—in other words, if the operating mode (according to step B3) can still be selected—then the operating mode will be determined in step B7, in accordance with the elevator call, which concerns either public zones Zp only (first operating mode) or non-public zones Zs (second operating mode).

In a step B8, the elevator car 10 is moved to the floor to be served in order to make the stop. Here, the car door 10a, 10b selected in step B6 is opened and closed again, the corresponding floor door 6, 6a, 7, 7a being moved along by the car door 10a, 10b. The elevator call is thus responded to and the method proceeds back to step B2.

In step B9, once a check has been made in step B5 that there is no further elevator call present according to operating mode defined in steps B3 or B4, it is checked whether a further elevator call is present which requires a check as to whether there is a further elevator call that requires a different operating mode. If no such elevator call is present, the method proceeds along the NO branch back to step B2, otherwise along the YES branch to a step B10.

In step B10, an alarm is generated as described in connection with step A10 in FIG. 6. In addition, the car door 10a, 10b and the corresponding floor door 6, 6a, 7, 7a are kept open until the elevator car 10 is empty. If this is the case, the alarm can be terminated. The process then proceeds back to step B2.

In one exemplary embodiment and based on the situation shown in FIG. 1 the passenger P inputs the elevator call at the elevator operating device 4 (shown as a destination call device). When the elevator car 10 is ready for boarding, i.e., the shaft door 6a and the car door 10a are open, the passenger P enters the car 10. In one exemplary embodiment, the information unit 25 arranged in the car 10 informs the passenger P that the car 10 is traveling to the access control floor L and they have to get out there. When the car 10 is at the access control floor L, the passenger P passes through the open car door 10a and the opened shaft door 6a into the first public zone Zp1. The monitoring device 24 checks whether the car 10 is then empty. In order to commence the journey to the desired utilization floor Ln after their detection by the personnel, the passenger P enters the first non-public zone Zs1 on the access control floor L. At the elevator operating device 4 arranged there, the passenger P inputs the desired utilization floor Ln (destination call). If the check by the monitoring device 24 reveals that the car 10 is empty, the elevator controller 13 will switch into the second operating mode. If the elevator car 10 is ready for boarding, i.e., the shaft door 7 and the car door 10b are open, the passenger P enters the car 10 and is transported to the desired utilization floor Ln.

In accordance with the provisions of the patent statutes, the present invention has been described in what is considered to represent its preferred embodiment. However, it should be noted that the invention can be practiced otherwise than as specifically illustrated and described without departing from its spirit or scope.

1-9. (canceled)

10. An elevator installation comprising:
an elevator controller;
an elevator car movable in an elevator shaft between floors of a building under control of the elevator controller, the elevator car having a first car door on a first car wall and a second car door on a second car wall;
a plurality of shaft doors that separate the elevator shaft from associated ones of the floors, wherein a first group of the shaft doors is arranged in public zones of the building and a second group of the shaft doors is arranged in non-public zones of the building;
wherein the elevator controller operates in a first operating mode to move the elevator car between the floors and to serve the public zones, the elevator controller controlling an opening of the first car door at each of the floors to be served that initiates an opening of the associated shaft door arranged at one of the public zones; and
wherein the elevator controller operates in a second operating mode to move the elevator car between the floors and to serve the non-public zones, the elevator controller controlling an opening of the second car door at each of the floors to be served that initiates an opening of the associated shaft door arranged at one of the non-public zones.

11. The elevator installation according to claim 10 including a monitoring device communicatively connected to the elevator controller and configured to generate a status signal that indicates whether a passenger is present in the elevator car, wherein the elevator controller only switches between the first operating mode and the second operating mode when the status signal generated by the monitoring device indicates that no passenger is present in the elevator car.

12. The elevator installation according to claim 10 including an information unit in the elevator car and communicatively connected to the elevator controller, wherein the information unit generates, under control of the elevator controller, a notification requesting a passenger to leave the elevator car.

13. The elevator installation according to claim 12 wherein the notification is an audiovisual notification.

14. The elevator installation according to claim 10 having a group of elevators wherein one of the elevators includes the elevator car and other ones of the elevators each include an elevator car having a first car door and a second car door, and wherein the elevators of the group are arranged next to one another in a row in the building.

15. The elevator installation according to claim 14 wherein the elevator controller is a group controller for the elevators.

16. The elevator installation according to claim 10 having a group of elevators wherein one of the elevators includes the elevator car and other ones of the elevators each include another elevator car, wherein the elevators of the group are arranged next to one another in the building, and wherein the another elevator car of at least one of the other elevators has only one car door.

17. The elevator installation according to claim 10 having a group of elevators wherein one of the elevators includes the elevator car, the group including an elevator sub-group of ones of the elevators having another elevator car with a single car door, wherein the elevators of the group are arranged in the building such that on an access control floor of the building the second car door the elevator car and the single car doors of the another elevator cars open onto one of the non-public zones.

18. A method for operating an elevator installation having an elevator controller, an elevator car movable in an elevator shaft between floors of a building under control by the elevator controller, the elevator car having a first car door on a first car wall and a second car door on a second car wall, and a plurality of shaft doors that separate the elevator shaft from the floors, wherein a first group of the shaft doors is arranged in public zones of the building and a second group of the shaft doors is arranged in non-public zones of the building, the method comprising the steps of:
operating the elevator controller by switching between a first operating mode and a second operating mode;
wherein, in the first operating mode, the elevator car is moved under control by the elevator controller between ones of the floors associated with the first group of shaft doors in order to serve the public zones, the elevator controller controlling an opening of the first car door thereby initiating an opening of the shaft door arranged in the public zone being served; and
wherein, in the second operating mode, the elevator car is moved under control by the elevator controller between ones of the floors associated with the second group of shaft doors in order to serve the non-public zones, the elevator controller controlling an opening of the second car door thereby initiating an opening of the shaft door arranged in the non-public zone being served.

19. The method according to claim 18 including evaluating a status signal generated by a monitoring device that is communicatively connected to the elevator controller, the status signal indicating whether a passenger is present in the elevator car, wherein the elevator controller only switches between the first operating mode and the second operating mode when the status signal generated by the monitoring device indicates that no passenger is present in the elevator car.

20. The method according to claim 18 including generating a notification by an information unit in the elevator car, the information unit being communicatively connected to the elevator controller, wherein the notification requests a passenger to leave the elevator car.

21. The method according to claim 20 wherein the notification is an audiovisual notification.
